(19) United States
(12) Patent Application Publication
(10) Pub. No.: US 2014/0146271 A1
(43) Pub. Date: May 29, 2014

(54) BACKLIGHT MODULE AND DISPLAY DEVICE INCLUDING THE SAME

(71) Applicant: InnoLux Corporation, Miao-Li County (TW)

(72) Inventor: Chia-Liang HUNG, Miao-Li County (TW)

(73) Assignee: InnoLux Corporation, Miao-Li County (TW)

(21) Appl. No.: 14/084,313

(22) Filed: Nov. 19, 2013

(30) Foreign Application Priority Data
Nov. 28, 2012 (TW) 101144429

(51) Int. Cl. G02F 1/1335; F21V 8/00

(52) U.S. Cl. CPC G02F 1/13362; G02B 6/0011
USPC 349/62; 362/609

(57) ABSTRACT

A backlight operated alternately in a first and a second mode and including a first and a second light source, a light guide, and an optical control member. The light guide is used to receive the light emitted from the second light source, and the optical control member is disposed below the light guide. When the backlight is operated in the first and the second modes, the optical control member has different transmittance with respect to light projected thereon, so as to improve image quality of a liquid-crystal display device using the same.

### CROSS REFERENCE TO RELATED APPLICATIONS

This Application claims priority of Taiwan Patent Application No. 101144429, filed on Nov. 28, 2012, the entirety of which is incorporated by reference herein.

### BACKGROUND OF THE INVENTION

1. Field of the Invention

The present invention relates to a liquid-crystal display device and a backlight module thereof, and in particular to a 2D/3D switchable liquid-crystal display device and a backlight module thereof.

2. Description of the Related Art

Conventional naked-eye type 3D display devices use lenticular and parallax-barrier technology to display a 3D image. In an application of the parallax-barrier type 3D display, images are separated by optical elements (such as a parallax device) to respectively allow the left eye and right eye of the viewer to see the left-eye image and right-eye image on the LCD panel to achieve the 3D effect.

The conventional backlight module of the parallax-barrier type display includes a 2D backlight module and a 3D backlight module disposed in front of the 2D backlight module. In 2D display mode, the 3D backlight module is switched off, and the 2D backlight module is switched on, so that a display panel is able to display the image by the light provided by the 2D backlight module. In 3D mode, the 2D backlight module is switched off, and the 3D backlight module is switched on, so that the display panel is able to display the image by the light provided by the 3D backlight module. However, some light produced by the 3D backlight module may project into the 2D backlight module, which leads to a light-leakage problem causing a 3D image display failure.

Manufacturers try to solve the above-mentioned problem by placing an optical attenuator made by a PMMA between the 2D backlight module and 3D backlight module to block light leaking from the 3D backlight module. However, the resulting effect is not as good as expected, since cross-talk interference of the 3D image may still occur due to the reflected light from the 2D backlight module. Moreover, the optical attenuator may decrease light utilization of the 2D backlight module.

Therefore, a 3D display which is able to prevent a decline in light utilization but without deteriorating display quality while switching between a 2D display and 3D display is highly desired.

### BRIEF SUMMARY OF THE INVENTION

In order to address the drawbacks of the conventional liquid-crystal display device, the disclosure provides a backlight module to enable a liquid-crystal display device to have better image quality.

In one embodiment, the backlight module which operates interchangeably in a first and a second mode includes a first light source, a second light source, a light guide plate, and an optical control member. The first and second light sources are configured to emit first and second light beams in the first and second modes, respectively. The light guide plate includes a light-incident surface for receiving the second light beams, two opposite side surfaces connected with the light-incident surface, and a plurality of light-guiding elements disposed at one of the side surfaces to reflect visible light. The optical control member has a first surface and a second surface opposite to the first surface. When the backlight module is operated in the first mode, the optical control module has a first transmittance with respect to the first light beams projected on the first surface. When the backlight module is operated in the second mode, the optical control module has a second transmittance with respect to the second light beams projected on the second surface, wherein the first transmittance is larger than the second transmittance.

In another embodiment, the first transmittance is in a range from 60% to 90%, and the second transmittance is in a range from 3% to 50%.

In still another embodiment, the backlight module further includes a DBEF disposed between the first light source and the optical control member, wherein the optical control member is a polarizing sheet, and the polarization direction of the polarizing sheet is the same as the polarization direction of the DBEF.

In yet another embodiment, the optical control member includes an electrochromic layer. When the backlight module is operated in the first mode, the electrochromic layer has the first transmittance, and when the backlight module is switched from the first mode to the second mode, the electrochromic layer is driven by a voltage, so that the electrochromic layer has the second transmittance.

In yet another embodiment, the two opposite sides of the light guide plate include a front light-emitting surface and a rear light-emitting surface. The front light-emitting surface is adjacent to the light-incident surface, and the rear light-emitting surface is opposite to the front light-emitting surface. The light-guiding elements are disposed on the rear light-emitting surface and include a plurality of recessed portions which are depressed toward to the inner side of the light guide plate, wherein a part of the second light beams are reflected on the recessed portions, and a part of the second light beams are projected into the optical control member through the rear light-emitting surface. Additionally, a gap is formed between the optical control member the rear light-emitting surface.

A liquid-crystal display device including any one of the above-mentioned backlight modules is also disclosed in the disclosure which includes a liquid-crystal panel configured to receive the first light beams and/or the second light beams from the backlight module and display an image.

In another embodiment, the liquid-crystal display device further includes an upper and a lower polarizer respectively disposed on two opposite surfaces of the liquid-crystal panel, wherein the polarization direction of the polarizing sheet is the same as the polarization direction of the lower polarizer.

Since the optical control member is capable of performing different optical properties while the backlight module is operated in different modes, the liquid-crystal display device using the same may have better image quality regardless of manifesting a 2D or 3D image.

### BRIEF DESCRIPTION OF THE DRAWINGS

The present invention is more fully understood by reading the subsequent detailed description and examples with references made to the accompanying drawings, wherein:

FIG. 1A shows a schematic view of a liquid-crystal display device while manifesting a 2D image in accordance with one embodiment of the disclosure, wherein a backlight module is operated in a first mode;

FIG. 1B shows a schematic view of the liquid-crystal display device shown in FIG. 1A while manifesting a 3D image, wherein the backlight module is operated in a second mode;

FIG. 2A shows a schematic view of a liquid-crystal display device while manifesting a 2D image in accordance with the other embodiment of the disclosure, wherein a backlight module is operated in a first mode;

FIG. 2B shows a schematic view of the liquid-crystal display device shown in FIG. 2A while manifesting a 3D image, wherein the backlight module is operated in a second mode;

FIG. 3 shows a schematic view of a liquid-crystal display device while manifesting a 2D image in accordance with the other embodiment of the disclosure; and

FIG. 4 shows a schematic view of a liquid-crystal display device while manifesting a 2D image in accordance with yet another embodiment of the disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

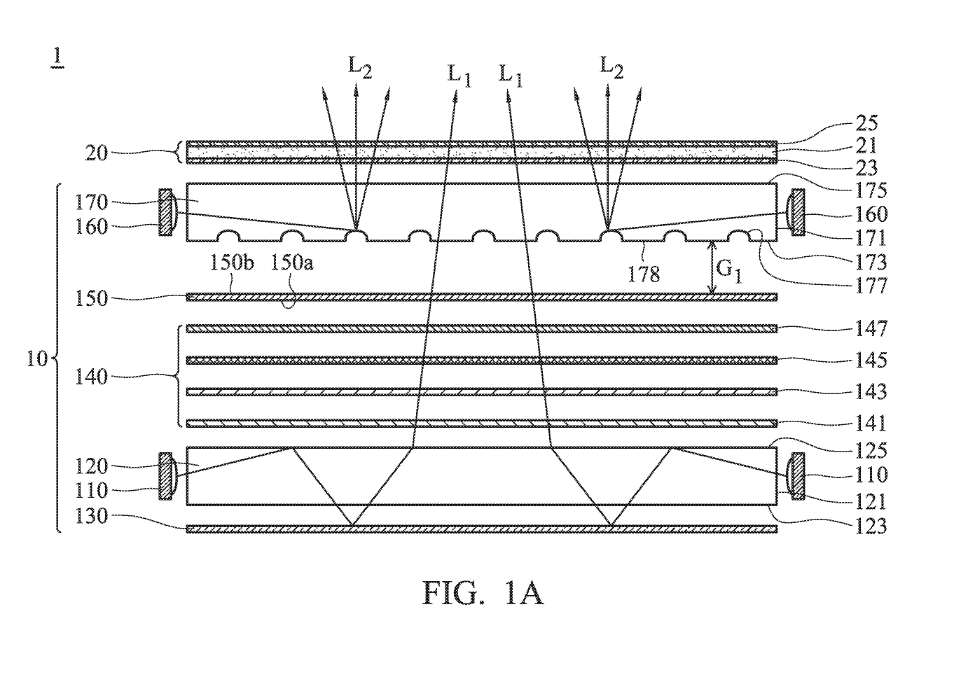

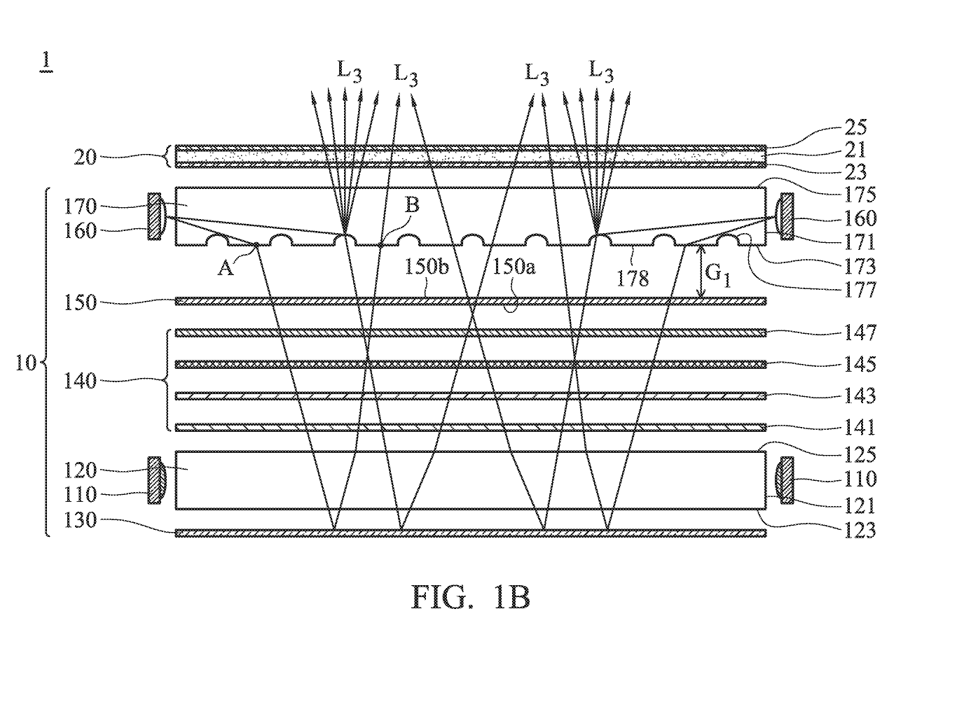

Referring to FIG. 1A, a liquid-crystal display device 1 of the disclosure includes a backlight module 10 and a liquid-crystal panel module 20. The backlight module 10 includes a plurality of first light sources 110, a first light guide 120 corresponding to the first light sources 110, a reflection plate 130, an optical film set 140, an optical control member 150, a plurality of second light sources 160, and a second light guide 170 corresponding to the second light sources 160.

Each of the first light sources 110 includes an LED, which is able to eradiate a first light beam L1. The first light guide 120 includes a first light-incident surface 121, a first rear light-emitting surface 123 and a first front light-emitting surface 125. The first rear light-emitting surface 123 is adjacent to the first light-incident surface 121 and opposite to the first front light-emitting surface 125. The first light-incident surface 121 faces the first light sources 110 to receive the first light beams L1 emitted from the first light sources 110. The reflection plate 130 used to improve light uniformity faces the first rear light-emitting surface 123 of the first light guide 120 to reflect light.

The optical film set 140 is disposed between the first light guide 120 and the optical control member 150. Specifically, the optical film set 140 is disposed on the first front light-emitting surface 125 of the first light guide 120. In one exemplary embodiment, the optical film set 140 includes a first diffusion film 141, a brightness enhancement film (BEF) 143, a second diffusion film 145 and a dual brightness enhancement film (DBEF) 147. The configuration of the optical film set 140 can be modified according to demand and is not limited to the above embodiment.

In the embodiment, the optical control member 150 is a polarizing sheet which has a first surface 150a and a second surface 150b opposite to the first surface 150a, wherein the first surface 150a faces the optical film set 140, and the second surface 150b faces the second light guide 170. In the embodiment, the polarization direction of the polarizing sheet 150 is the same as the polarization direction of the DBEF 147.

Each of the second light sources 160 includes an LED, which is able to eradiate a second light beam L2. The second light guide 170 includes a second light-incident surface 171, a second rear light-emitting surface 173 and a second front light-emitting surface 175. The second rear light-emitting surface 173 is adjacent to the second light-incident surface 171 and opposite to the second front light-emitting surface 175. The second light-incident surface 171 faces the second light sources 160 to receive the second light beams L2 emitted from the second light sources 160. The second rear light-emitting surface 173 faces the optical control member 150 and includes a plurality of light-guiding elements to reflect visible light. For example, the second rear light-emitting surface 173 includes a plurality of recessed portions 177 depressed toward to the inner side of the second light guide plate 170. Ink with high reflective properties is applied to the inner surface of the recessed portions 177 to reflect the second light beams L2 from the second light sources 160.

The liquid-crystal panel module 20 faces the front light-emitting surface 175 of the second light guide 170 and includes a liquid-crystal panel 21, a lower polarizer 23, and an upper polarizer 25. The lower and upper polarizers 23 and 25 are disposed on two opposite surfaces of the liquid-crystal panel 21 respectively, wherein the polarization direction of the lower polarizer 23 is the same as the polarization direction of the polarizing sheet 150. The liquid-crystal panel 21 includes a plurality of pixel units (not shown), and each of the pixel units includes a left sub-pixel unit and a right sub-pixel unit, wherein each of the pixel units corresponds to one of the recessed portions 177 of the second light guide 170. It should be noted that the second rear light-emitting surface 173 of the second light guide 170 does not connect with the polarizing sheet 150, and a gap G₁ is formed therebetween to enhance the light-emitting efficiency of the second light guide 170.

The operational method of the liquid-crystal display device 1 is described in detail. Referring to FIGS. 1A and 1B: FIG. 1A shows a schematic view of the liquid-crystal display device 1 while manifesting a 2D image, wherein the backlight module 10 is operated in the first mode, and FIG. 1B shows a schematic view of the liquid-crystal display device 1 while manifesting a 3D image, wherein the backlight module 10 is operated in the second mode.

When the backlight module 10 is operated in the first mode, as shown in FIG. 1A, the first light beams L1 emitted from the first light sources 110 are projected into the optical film set 140 via the first light guide plate 120. The light uniformity of the first light beams L1 is improved by the optical film set 140, and the first light beams L1 are polarized by the DBEF 147. Since the polarization direction of the polarizing sheet 150 is the same as the polarization direction of the DBEF 147, most of the first light beams L1 from the DBEF 147 of the optical film sheet 140 and being projected into the first surface 150a of the polarizing sheet 150 are able to pass through the polarizing sheet 150. In one embodiment, the transmittance of the polarizing sheet 150 with respect to the first light beams L1 incident into the first surface 150a of the polarizing sheet 150 is a first transmittance of 83%. Alternatively, the first transmittance may be in a range of 60% to 90%. Subsequently, the first light beams L1 penetrating through the second light guide 170 is projected into the liquid-crystal panel module 20 to illuminate the liquid-crystal panel module 20.

With the arrangement of the backlight module 10, the light utilization of the first light beams L1 from the first light source 110 is improved. In an exemplary experimental result, with respect to light from the first light source, the transmittance of the first light guide 120 is 90%; the transmittance of the first diffusion sheet 141 is 90%; the transmittance of the BEF 143 is 120%; the transmittance of the second diffusion sheet 145 is 90%; the transmittance of the DBEF 147 is 68%; and the transmittance of the polarizing sheet 150 is 44%. Therefore, the light utilization rate of the first light source 110 of the backlight module 10 is 25%. Conversely, in cases where the polarizing sheet 150 is replaced with a Polymethylmethacrylate comprising carbon pigment particles and the other elements are arranged as shown in FIG. 1A, the light utilization rate of the first light source 110 is decreased to 18.6%.

However, since the first light beams L1 may be blocked by the recessed portions 177 of the second light guide plate 170, this may cause degradation in the optical uniformity of the second light guide plate 170. To address this problem, a method is provided in the embodiment. As shown in FIG. 1A, when the backlight module 10 is operated in the first mode, the second light source 160 is turned on simultaneously, wherein the second light beams L2 from the second light source 160 penetrate through the second light-incident surface 171 of the second light guide plate 170 and are reflected to the liquid-crystal panel module 20 by the reflective ink (not shown) at the recessed portion 177. It should be noted that it is not necessary to turn on the second light source 160 when the liquid-crystal display device 1 is operated in 2D display mode, and instead the light beams L2 provided from the second light source 160 are used to increase the optical uniformity.

Referring to FIG. 1B, when the liquid-crystal display device 1 is operated in the 3D display mode, the second light sources 160 corresponding to the two opposite second light-incident surfaces 171 of the second light guide plate 170 are instantly switched on and off to emit second light beams L3 alternatively. Some of the second light beams L3 entering the second light guide plate 170 are reflected by the reflective ink (not shown) and leave the second light guide plate 170 to illuminate the liquid-crystal panel 21 and to provide a direction backlight to produce a 3D image. While some of the second light beams L3 may project into the second surface 150b of the polarizing sheet 150 through the recessed portions 177 and the space 178 located between two adjacent recessed portions 177, the amount of second light beams L3 that are transmitted through the polarizing sheet 150 may weaken remarkably because the second light beams L3 are unpolarized light and the polarizing sheet 150 passes the second light beams L3 of a specific polarization and blocks waves of other polarizations. In one exemplary embodiment, the transmittance of the polarizing sheet 150 with respect to the second light beams L3 incident into the second surface 150b of the polarizing sheet 150 is a second transmittance of 44%. Alternatively, the second transmittance may be in a range of 3% to 50%. Next, the second light beams L3 passing through the polarizing sheet 150 may sequentially pass through the optical film set 140 and the first light guide plate 120 and be reflected by the reflection plate 130. After being reflected by the reflection plate 130, the second light beams L3 may sequentially pass through the first light guide plate 120, the optical film set 140, the polarizing sheet 150, and enter the second light plate 170.

Through the arrangement of the backlight module 10, cross-talk interference can be reduced. In an exemplary experimental result, with respect to the second light beams L3 projected into the reflection plate 130 through the recessed portions 177 and the space 178, the transmittance of the polarizer 150 is 44%; the transmittance of the first diffusion sheet 141 is 90%; the transmittance of the BEF 143 is 120%; the transmittance of the second diffusion sheet 145 is 90%; the transmittance of the DBEF 147 is 68%; and the reflection rate of the reflection plate 130 is 97%.

With respect to the second light beams L3 reflected by the reflection plate 130 and projected into the second light guide plate 170, the transmittance of the first light guide 120 is 90%; the transmittance of the first diffusion sheet 141 is 90%; the transmittance of the BEF 143 is 90%; the transmittance of the second diffusion sheet 145 is 90%; the transmittance of the DBEF 147 is 68%; and the transmittance of the polarizer 150 is 44%. Therefore, the light leakage rate (a ratio of light intensity of the second light beams L3 at point B in FIG. 1B to light intensity of the second light beams L3 at point A in FIG. 1B) is 6.345%. Conversely, in cases where the polarizing sheet 150 is replaced with a Polymethylmethacrylate sheet comprising carbon pigment particles and other elements are arranged as shown in FIG. 1A, the light leakage rate of the second light source 160 is 6.8475%.

Generally speaking, the backlight module 10 of the embodiment can not only reduce cross-talk interference while the liquid-crystal display device 1 is manifesting a 3D image, but increase the light utilization of the backlight module 10 while the liquid-crystal display device 1 is manifesting a 2D image, wherein the ratio of light utilization (25%) of the first light source 110 and light leakage rate (9.4%) of the second light source 160 is 3.94.

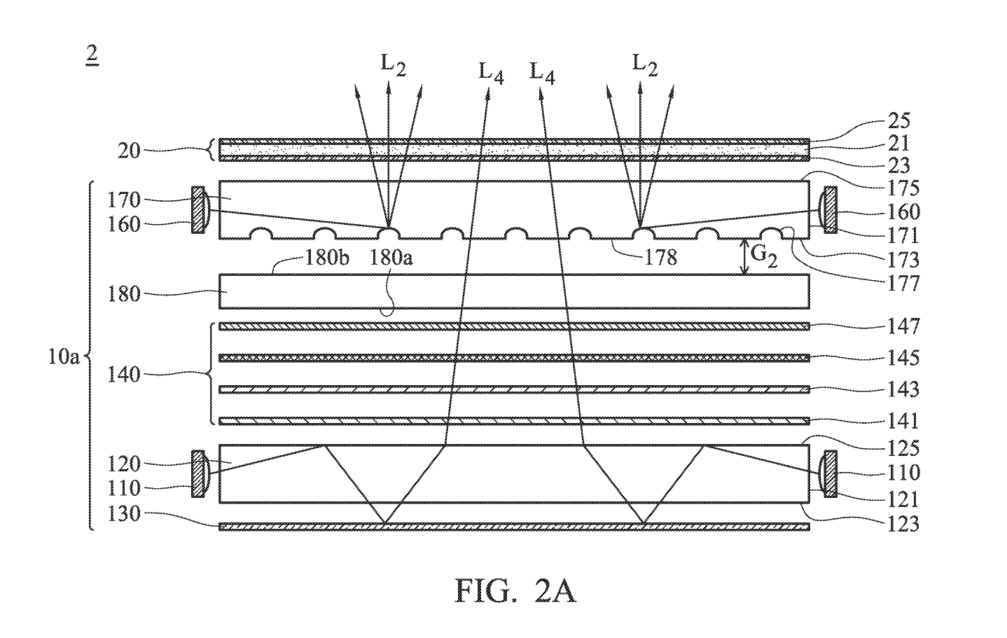

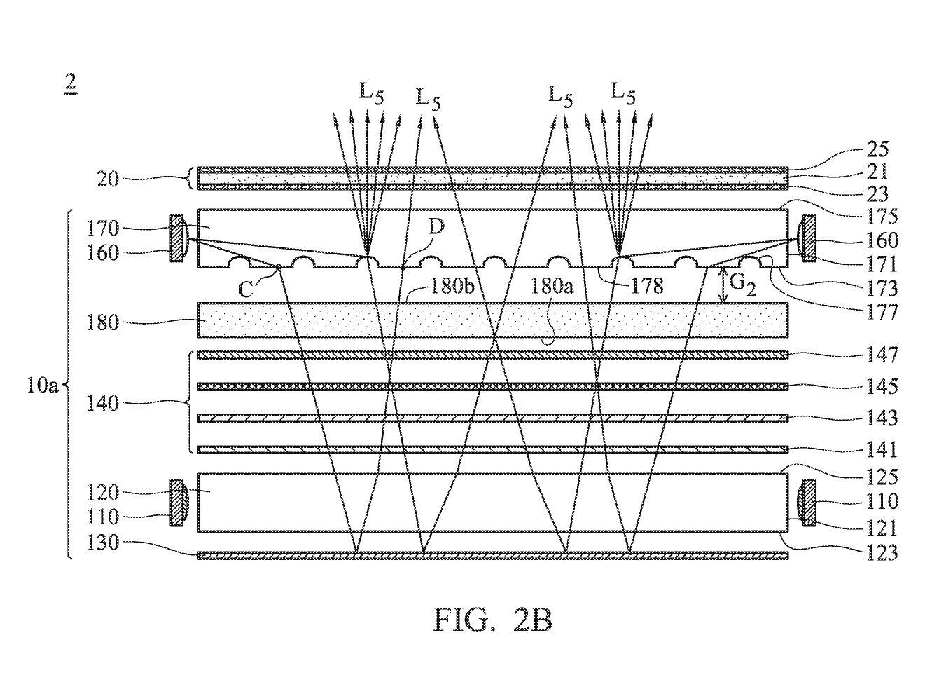

Referring to FIG. 2A, a schematic view of a liquid-crystal display device 2 in accordance with the other embodiment is shown in FIG. 2A, in which elements similar with those of the liquid-crystal display device 1 shown in FIG. 1A are provided with the same reference numbers, and the features thereof are not reiterated in the interests of brevity. The liquid-crystal display device 2 differs from the liquid-crystal display device 1 in that the optical control member 150 is replaced with the optical control member 180. The optical control member 180 has a first surface 180a and a second surface 180b opposite to the first surface 180a, wherein the first surface 180a faces the optical film set 140, and the second surface 180b faces the second light guide 170, wherein a gap G2 is formed therebetween to enhance the light-emitting efficiency of the second light guide 170. The optical control member 180 includes an electrochromic layer and two electrodes (not shown) disposed at two opposite sides of the electrochromic layer, arranged such that the transmittance of the optical control member 180 is decreased when a voltage is applied to the electrochromic layer by the two electrodes.

The operational method of the liquid-crystal display device 2 is described in detail. Referring to FIGS. 2A and 2B: FIG. 2A shows a schematic view of the liquid-crystal display device 2 while manifesting a 2D image, wherein the backlight module 10a is operated in the first mode, and FIG. 2B shows a schematic view of the liquid-crystal display device 2 while manifesting a 3D image, wherein the backlight module 10a is operated in the second mode.

When the backlight module 10a is operated in the first mode, as shown in FIG. 2A, the first light beams L1 emitted from the first light source 110 sequentially pass through the first light guide plate 120 and the optical film set 140 and are projected into the optical control member 180. Since there is no voltage being applied to the electrochromic layer by the two electrodes, the optical control member 180 has a high transmittance. In one exemplary embodiment, the transmittance of the optical control member 180 with respect to the first light beams L4 incident into the first surface 180a of the optical control member 180 is a first transmittance, which is in a rage of 60% to 90%. Therefore, the light utilization of the first light source 110 is 18.6%.

When the backlight module 10a is operated in the second mode, as shown in FIG. 2B, some of the second light beams L5 may project into the second surface 180b of the optical control member 180 through the recessed portions 177 and the space 178. While at the same time, a voltage is applied to the electrochromic layer of the optical control member 180 by the two electrodes thereof to decrease the transmittance of the optical control member 180. In one exemplary embodiment, the transmittance of the optical control member 180 with respect to the first light beams L5 incident into the second surface 180b of the optical control member 180 is a second transmittance of 4%. Alternatively, the second transmittance may be in a range of 3% to 50%. Next, the second light beams L5 passing through the optical control member 180 may sequentially pass through the optical film set 140 and the first light guide plate 120 and be reflected by the reflection plate 130. After being reflected by the reflection plate 130, the second light beams L5 may sequentially pass through the first light guide plate 120, the optical film set 140, and the optical control member 180, and enter the second light plate 170 again. In the embodiment, the light leakage rate (a ratio of light intensity of the second light beams L5 at point D in FIG. 2B and light intensity of the second light beams L5 at point C in FIG. 2B) is 0.0256%.

Generally speaking, the backlight module 10a of the embodiment can not only reduce cress-talk interference while the liquid-crystal display device 2 is manifesting a 3D image, but increase the light utilization of the backlight module 10a while the liquid-crystal display device 2 is manifesting a 2D image, wherein the ratio of the light utilization (18.6%) of the first light source 110 and light leakage rate (0.0256%) of the second light source 160 is 726.56. That is to say, the liquid-crystal display device 2 has better image quality than the liquid-crystal display device 1.

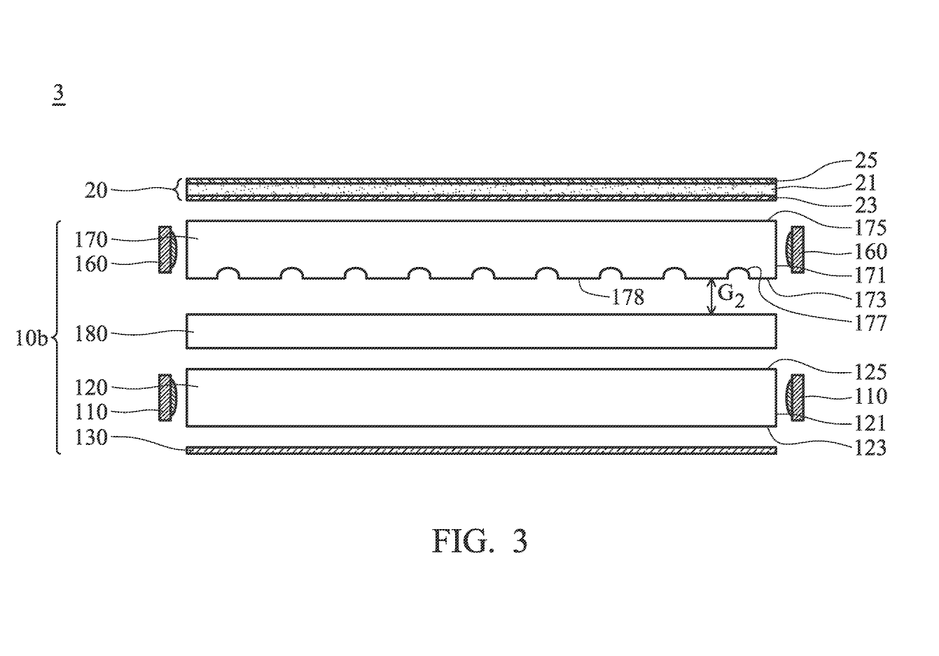

Referring to FIG. 3: A schematic view of a liquid-crystal display device 3 in accordance with the other embodiment is shown in FIG. 3, in which elements similar to those of the liquid-crystal display device 2 shown in FIG. 2A are provided with the same reference numbers, and the features thereof are not reiterated in the interest of brevity. The liquid-crystal display device 3 differs from the liquid-crystal display device 2 in that the optical film set 140 is omitted. Therefore, the light utilization of the first light source 110 may be increased further.

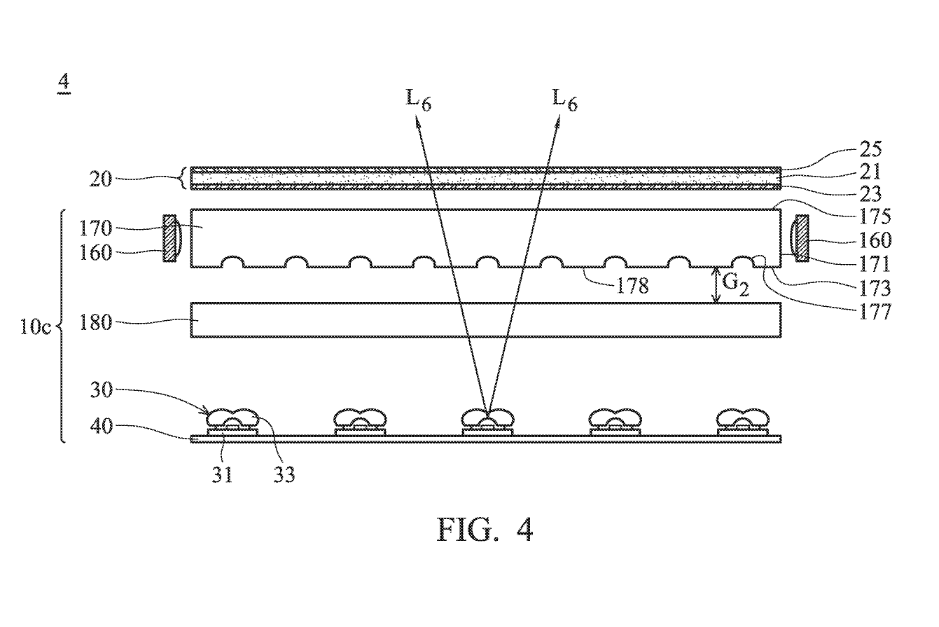

Referring to FIG. 4: A schematic view of a liquid-crystal display device 4 in accordance with the other embodiment is shown in FIG. 4, in which elements similar to those of the liquid-crystal display device 2 shown in FIG. 2A are provided with the same reference numbers, and the features thereof are not reiterated in the interest of brevity. The liquid-crystal display device 4 differs from the liquid-crystal display device 2 in that the liquid-crystal display device 4 is a directly-lit LCD, wherein the backlight module 10c includes a plurality of first light source 30, substrate 40, a plurality of second light sources 160, a second light guide plate 170, and an optical control member 180.

The plurality of first light sources 30 is disposed on the substrate 40, and each of the first light sources 30 includes an LED 31 and an optical lens 33 covering the LED 31. The first light beams L6 emitted from the LEDs 31 are uniformly diffused by the optical lenses 33 and are projected into the liquid-crystal panel module 20. In some embodiments, the substrate 40 has reflective properties. In still other embodiments, the substrate 40 has no reflective properties, the light leaking from the spaces 178 of the light guide plate 170 is not reflected by the substrate 40 so as to reduce cross-talk interference when the liquid-crystal display device 4 is operated to manifest a 3D image.

While the invention has been described by way of example and in terms of preferred embodiment, it is to be understood that the invention is not limited thereto. On the contrary, it is intended to cover various modifications and similar arrangements (as would be apparent to those skilled in the art). In addition, the number of light sources is selected according to demand, for example, one or more LEDs facing the edge of the light guide plate may be used.

What is claimed is:

1. A backlight module, operated alternately in a first and a second mode, comprising:
a first light source, emitting a first light beam in the first mode;
a second light source, emitting a second light beam in the second mode;
a light guide plate, comprising:
a light-incident surface, receiving the second light beam from the second light source;
two opposite side surfaces, connecting with the light-incident surface; and
a plurality of light-guiding elements, disposed on one of the side surfaces and configured to reflect visible light; and
an optical control member, disposed below the light guide plate and having a first surface and a second surface opposite to the first surface, wherein when the light module is operated in the first mode, the optical control module has a first transmittance with respect to the first light beam projected on the first surface, and when the light module is operated in the second mode, the optical control module has a second transmittance with respect to the second light beam projected on the second surface, wherein the first transmittance is larger than the second transmittance.

2. The backlight module as claimed in claim 1, wherein the first transmittance is in a range from 60% to 90%.

3. The backlight module as claimed in claim 1, wherein the second transmittance is in a range from 3% to 50%.

4. The backlight module as claimed in claim 1, further comprising a DBEF disposed between the first light source and the optical control member, wherein the optical control member is a polarizing sheet, and the polarization direction of the polarizing sheet is the same as the polarization direction of the DBEF.

5. The backlight module as claimed in claim 1, wherein the optical control member comprises an electrochromic layer.

6. The backlight module as claimed in claim 5, wherein when the backlight module is operated in the first mode, the electrochromic layer has the first transmittance.

7. The backlight module as claimed in claim 6, wherein when the backlight module is switched from the first mode to the second mode, the electrochromic layer is driven by a voltage, so that the electrochromic layer has the second transmittance.

8. The backlight module as claimed in claim 1, wherein the two opposite sides of the light guide plate comprise:
a front light-emitting surface, adjacent to the light-incident surface; and
a rear light-emitting surface, opposite to the front light-emitting surface.

9. The backlight module as claimed in claim 8, wherein the light-guiding elements are disposed on the rear light-emitting surface and comprise:
a plurality of recessed portions, depressed toward to the inner side of the light guide plate, wherein a part of the second light beam is reflected on the recessed portions, and a part of the second light beam is emitted into the optical control member through the rear light-emitting surface.

10. The backlight module as claimed in claim 8, wherein a gap is formed between the optical control member and the rear light-emitting surface.

11. A liquid-crystal display device, comprising:
a backlight module operated alternately in a first and a second mode and comprising:
a first light source, emitting a first light beam in the first mode;
a second light source, emitting a second light beam in the second mode;
a light guide plate, comprising:
a light-incident surface, receiving the second light beam from the second light source;
two opposite side surfaces, connecting with the light-incident surface; and
a plurality of light-guiding elements, disposed on one of the side surfaces and configured to reflect visible light; and
an optical control member, disposed below the light guide plate and having a first surface and a second surface opposite to the first surface, wherein when the light module is operated in the first mode, the optical control module has a first transmittance with respect to the first light beam projected on the first surface, and when the light module is operated in the second mode, the optical control module has a second transmittance with respect to the second light beam projected on the second surface, wherein the first transmittance is larger than the second transmittance; and
a liquid-crystal panel, configured to receive the first light beam or the second light beam from the backlight module to display an image.

12. The liquid-crystal display device as claimed in claim 11, wherein the first transmittance is in a range from 60% to 90%.

13. The liquid-crystal display device as claimed in claim 11, wherein the second transmittance is in a range from 3% to 50%.

14. The liquid-crystal display device as claimed in claim 11, further comprising an upper and a lower polarizer respectively disposed on two opposite surfaces of the liquid-crystal panel, wherein the optical control member is a polarizing sheet, and the polarization direction of the polarizing sheet is the same as the polarization direction of the lower polarizer.

15. The liquid-crystal display device as claimed in claim 1, wherein the optical control member comprises an electrochromic layer.

16. The liquid-crystal display device as claimed in claim 15, wherein when the backlight module is operated in the first mode, the electrochromic layer has the first transmittance.

17. The liquid-crystal display device as claimed in claim 16, wherein when the backlight module is switched from the first mode to the second mode, the electrochromic layer is driven by a voltage, so that the electrochromic layer has the second transmittance.

18. The liquid-crystal display device as claimed in claim 11, wherein the two opposite sides of the light guide plate comprise:
a front light-emitting surface, adjacent to the light-incident surface; and
a rear light-emitting surface, opposite to the front light-emitting surface.

19. The liquid-crystal display device as claimed in claim 18, wherein the light-guiding elements are disposed on the rear light-emitting surface and comprise:
a plurality of recessed portions, depressed toward to the inner side of the light guide plate, wherein a part of the second light beam is reflected on the recessed portions, and a part of the second light beam is emitted into the optical control member through the rear light-emitting surface.
